(19) United States
(12) Patent Application Publication
(10) Pub. No.: US 2014/0073729 A1
(43) Pub. Date: Mar. 13, 2014

(54) Infrared-Reflecting Pigment Based on Titanium Dioxide, and a Method for Its Manufacture

(71) Applicant: Kronos International, Inc., Leverkusen (DE)

(72) Inventors: Michael Schmidt, Bergisch Gladbach (DE); Katja Scharf, Heiligenhaus (DE)

(73) Assignee: Kronos International, Inc., Leverkusen (DE)

(21) Appl. No.: 14/017,474

(22) Filed: Sep. 4, 2013

Related U.S. Application Data
(60) Provisional application No. 61/718,249, filed on Oct. 25, 2012.

(30) Foreign Application Priority Data
Sep. 8, 2012 (DE) 2012017854.9

(51) Int. Cl. C09C 1/36

(52) U.S. Cl. CPC C09C 1/3607
USPC 524/432; 106/428

(57) ABSTRACT

The invention relates to rutile titanium dioxide pigment particles that are capable of reflecting infrared radiation to a high degree and also display pigmenting properties, as well as a method for their manufacture. The particles have a mean particle size of 0.4 to 1.0 μm and are doped with zinc and potassium, but not with aluminium. Preferably, the particles have a compact particle form with a preferred height:width ratio of 1.5:1. The particles are preferably manufactured by the familiar sulphate process for manufacturing titanium dioxide, and are optionally subjected to inorganic and/or organic post-treatment following calcining. Preferably, the rutile titanium dioxide particles are suitable for manufacturing heat-insulating paints, coatings or plastics as well as for instance plasters or paving stones.

### RELATED APPLICATIONS

This application claims the benefit of U.S. Provisional Patent Application Ser. No. 61/718,249 filed Oct. 25, 2012, and entitled “Infrared-Reflecting Pigment Based on Titanium Dioxide, and a Method for Its Manufacture” and the benefit of DE 10 2012 017 854.9 filed Sep. 8, 2012.

### BACKGROUND

1. Field of the Invention

The invention relates to rutile titanium dioxide pigment particles that are both capable of reflecting infrared radiation to a high degree and display pigmenting properties, as well as a method for their manufacture. The titanium dioxide particles are suitable for manufacturing heat-insulating paints, coatings or plastics as well as for instance plasters or paving stones.

2. Description of Related Art

The term infrared radiation is customarily used to denote the electromagnetic radiation in the wavelength range directly above that of visible light, i.e. from 780 nm to roughly 1 mm. The sunlight reaching the surface of the Earth essentially lies in the wavelength range from 300 to 2,500 nm and is composed of roughly 3% ultraviolet radiation (UV), roughly 53% visible light and roughly 44% infrared radiation (IR).

According to the Mie theory, electromagnetic radiation is optimally reflected by particles with a particle size corresponding to half the wavelength of the electromagnetic radiation. Pigmentary titanium dioxide particles thus have a particle size distribution of roughly 0.2 to 0.4 μm, corresponding to half the wavelength of visible light (380 to 780 nm). Particles with sizes ranging from roughly 0.4 to 1.3 μm are suitable for reflecting IR radiation in the wavelength range from 780 nm to 2,500 nm.

EP 1 580 166 A1 discloses titanium dioxide particles with primary particle sizes of 0.5 to 2.0 μm that selectively reflect IR radiation and favour the easy spreading of cosmetic preparations manufactured with them. The particles are manufactured by mixing hydrated titanium oxide with an aluminium compound, a zinc compound and a potassium compound, this being followed by calcining. The particles according to EP 1 580 166 A1 are rod-shaped.

U.S. Pat. No. 5,811,180 A discloses pigments that are said to reflect the heat radiated by fire. The particle size is in excess of 1 μm, and the particles can consist of flocculates of smaller primary particles.

U.S. Pat. No. 5,898,180 A discloses an IR-reflecting enamel composition for cooking utensils that contains TiO₂ particles, preferably rutile. The rutile particles are recrystallised by tempering the enamel composition, this intensifying their IR-reflecting properties.

WO 2009/136141 A1 discloses a coloured IR-reflecting composition containing TiO₂ particles that have a crystal size in excess of 0.4 μm and display an inorganic coating.

U.S. Pat. No. 6,113,973 A discloses an anatase titanium dioxide pigment with increased color stability and a particle size in the range of 0.1 to 1 μm that is doped with aluminium and/or zinc.

### BRIEF DESCRIPTION OF THE INVENTION

An object of the present invention consists in providing an alternative, titanium dioxide-based pigment that reflects in the near infrared range and displays no significant loss of brightness, compared to customary titanium dioxide pigments.

The object is solved by an infrared-reflecting pigment based on titanium dioxide that contains rutile titanium dioxide particles characterised by the following features:
The particle size d₅₀ is in the range from 0.4 to 1 μm,
The titanium dioxide particles are doped with zinc and potassium, and they are not doped with aluminium.

This object is further solved by a method for manufacturing an infrared-reflecting pigment based on titanium dioxide, where:

an iron/titanium-containing raw material is digested with sulphuric acid, producing iron sulphate and titanyl sulphate,

the iron sulphate is separated off and the titanyl sulphate is hydrolysed,

the resultant titanium oxyhydrate is subjected to a bleaching step,

the bleached titanium oxyhydrate is mixed with rutile nuclei, a zinc compound and a potassium compound, but not with an aluminium compound, and then calcined, producing rutile titanium dioxide particles with a particle size d₅₀ of 0.4 to 1 μm.

Further advantageous embodiments of the invention are indicated in the sub-claims.

### BRIEF DESCRIPTION OF THE FIGURES

For a more complete understanding of the present invention and for further advantages thereof, reference is made to the following description taken in conjunction with the accompanying figures in which:

FIG. 1 is a scanning electron microscope image of the particles from Example 2;

FIG. 2 is a scanning electron microscope image of the particles from the Reference Example;

FIG. 3 is a graph of the measured reflection spectra of an alkyd paint with particles of Example 1 incorporated showing the percent reflection on the ordinate axis and the wavelength in nm on the abscissa axis;

FIG. 4 is a graph of the measured reflection spectra of an alkyd paint with particles of Example 2 incorporated showing the percent reflection on the ordinate axis and the wavelength in nm on the abscissa axis.

### DESCRIPTION OF THE PREFERRED EMBODIMENTS

The present invention can be better understood by the following discussion of the manufacture and use of certain preferred embodiments. All data disclosed below regarding size in μm etc., concentration in % by weight or % by volume, pH value, etc. are to be interpreted as including all values lying in the range of the respective measuring accuracy known to the person skilled in the art. All disclosed ranges are to be interpreted as also including all values lying within the stated range. Unless otherwise stated, technical grades of the various materials were used in the preferred embodiments.

The term “particle size” is taken below to mean the measuring results obtained when determining the particle size of a powder, in this case when measuring titanium dioxide particles, with a disc centrifuge (e.g. DC 20000 disc centrifuge from Messrs. CPS).

The invention is based on the fact that titanium dioxide particles with a mean particle size d₅₀ in the range from 0.4 to 1.3 μm reflect IR radiation. It is generally known that titanium dioxide can be manufactured by different methods. The methods most commonly used on a commercial scale worldwide are known as the sulphate process and the chloride process.

The person skilled in the art is familiar with different versions of the process for producing TiO₂ particles with coarser particle sizes than customary TiO₂ pigment. WO 2009/136141 A1, the content of which is incorporated by reference herein, contains a general compilation of such process versions, which particularly relate to the sulphate process, such as an increase in the calcining temperature or calcining time, the addition of additives promoting crystal growth, or the reduction of the addition of rutile nuclei. However, no information is provided regarding specific additives or quantities.

In a preferred embodiment, the present invention illustrates a simple and economical way of manufacturing rutile TiO₂ particles with a mean particle size d₅₀ of 0.4 to 1 μm that are doped with zinc and potassium. The particles are not doped with aluminium. The particles have a compact particle form.

The particles preferably contain 0.2 to 0.25% by weight zinc, calculated as ZnO, and 0.18 to 0.26% by weight potassium, calculated as K₂O, each referred to TiO₂.

In a special embodiment, the particles have a maximum height:width ratio of 1.5:1.

It has surprisingly been found that, when used as a calcining additive, the combination of ZnO and K₂O in the absence of Al₂O₃ according to the invention leads to a mean particle size d₅₀ of 0.4 to 1 μm and a compact particle form.

In the context of the invention, the term “particle size d₅₀” is used to denote the median of a mass-related particle size distribution, determined using an X-ray disc centrifuge (e.g. DC 20000 disc centrifuge from Messrs. CPS).

Compared to the rod-shaped particles obtained by the method according to EP 1 580 166 A1, compact particles, especially spherical particles, are advantageous for achieving optimum reflection in the near IR range. In addition, compact particles are more easily dispersed in the user matrix than rod-shaped particles.

The IR-reflecting rutile titanium dioxide according to the preferred embodiment can be preferably manufactured by calcining titanium oxyhydrate, to which rutile nuclei, a zinc compound and a potassium compound are added, but no aluminium compound.

The titanium oxyhydrate is preferably manufactured by the sulphate process. Titanium oxyhydrate is also taken to mean titanium hydrate, metatitanic acid, titanium hydroxide, hydrous titanium oxide or titanium oxohydrate. In the sulphate process for manufacturing titanium dioxide, the iron/titanium-containing raw material, particularly ilmenite, is digested with sulphuric acid, producing iron sulphate and titanyl sulphate. The iron sulphate is customarily crystallised out and separated off. The titanyl sulphate is subsequently hydrolysed and the resultant titanium oxyhydrate subjected to a bleaching step to largely remove colouring transition metals. The bleached titanium oxyhydrate is then separated off, filtered and washed. Rutile nuclei, at least one zinc compound and at least one potassium compound are subsequently added to the titanium oxyhydrate, but no aluminium compound. The titanium oxyhydrate is subsequently calcined at roughly 950 to 1,050° C., producing rutile titanium dioxide particles. The person skilled in the art is familiar with the individual steps of the sulphate process for manufacturing titanium dioxide, e.g. from: G. Buxbaum, ed., “Industrial Inorganic Pigments”, VCH Verlagsgesellschaft mbH, 1993, pp. 51-55.

The rutile titanium dioxide particles manufactured by the method according to the invention have a compact form. The particle size d₅₀ is in the range from 0.4 to 1 μm. The height:width ratio is preferably a maximum of 1.5:1. 0.5 to 1.0% by weight rutile nuclei are preferably added, referred to TiO₂.

The zinc acts as a crystal growth promoter in TiO₂ production. Examples of suitable zinc compounds include zinc sulphate, zinc oxide or zinc hydroxide, preference being given to zinc oxide. The compound can be added in the form of an aqueous solution or suspension. The quantity added is preferably such that the rutile titanium dioxide particles contain 0.1 to 0.8% by weight zinc, preferably 0.2 to 0.4% by weight zinc and particularly 0.2 to 0.25% by weight zinc, calculated as ZnO and referred to TiO₂.

The potassium acts as a sintering inhibitor in TiO₂ production. Examples of suitable potassium compounds include potassium sulphate or potassium hydroxide, preference being given to potassium hydroxide. The compound can be added in the form of an aqueous solution or a salt. The quantity added is preferably such that the rutile titanium dioxide particles contain 0.1 to 0.4% by weight potassium, preferably 0.18 to 0.26% by weight potassium, calculated as K₂O and referred to TiO₂.

Following calcining, the rutile titanium dioxide particles according to the preferred embodiment can be subjected to a milling operation in order to crush agglomerates or aggregates. Suitable for this purpose are pendulum mills, agitator mills, hammer mills or steam mills, for example.

In a special embodiment of the method, the rutile titanium dioxide particles are subsequently subjected to inorganic and/or organic surface treatment.

The inorganic surface treatment encompasses the customary methods, such as also used for titanium dioxide pigments. For example, the titanium dioxide particles according to the invention can be coated with an SiO₂ layer and subsequently with an Al₂O₃ layer. In particular, a dense or a fluffy SiO₂ layer can be applied, e.g. such as described in: H. Weber, “Silicic acid as a constituent of titanium dioxide pigments”, Kronos Information 6.1 (1978), the content of which is incorporated herein by reference. It is known that coating with inorganic oxides, such as SiO₂, ZrO₂, SnO₂, Al₂O₃, etc., increases the photostability of TiO₂ particles and, in particular, that an outer Al₂O₃ layer improves dispersion of the particles in the user matrix.

Following inorganic surface treatment, the particles can be disagglomerated in a steam mill or a similar microniser.

When treating the surface of the rutile TiO₂ particles according to the invention, it must be borne in mind that, compared to the surface treatment of known TiO₂ pigment particles, the untreated particles according to the invention (particles sizes d₅₀ from 0.4 to 1 μm) display a far smaller specific surface area according to BET (roughly 2 to 6 m²/g) than untreated pigment particles (particle size d₅₀ roughly 0.3 μm, specific surface area roughly 8 to 10 m²/g). Thus, if the same quantity of substance were to be added during surface treatment, a considerably thicker coating would be formed on the coarser particle.

The compounds customarily used in the post-treatment of TiO₂ pigment particles can be used for organic post-treatment. The following compounds are suitable, for example: (poly-) alcohols, such as trimethylolpropane (TMP), silicone oils, siloxanes, organophosphates, amines, stearates.

The infrared-reflecting rutile titanium dioxide particles according to the invention can be used in paints, coatings and plastics as well as for instance in plasters or paving stones to reflect thermal radiation.

### EXAMPLES

The invention is described in more detail on the basis of the examples below, although this is not to be interpreted as a limitation of the invention.

### Example 1

Titanium oxyhydrate produced by the sulphate process for manufacturing titanium dioxide was used. The washed titanium oxyhydrate paste was slurried in water (300 g/l TiO₂) and mixed with 0.2% by weight ZnO in the form of zinc oxide, 0.22% by weight K₂O in the form of potassium hydroxide and 1% by weight rutile nuclei. The suspension was subsequently dried at 120° C. for 16 hours. 3 kg of the dried material were subsequently calcined into TiO₂ (rutile) in a rotary kiln at 920° C. for 2 hours and milled in a spiral jet mill.

The milled TiO₂ was slurried in water (350 g/l) and milled in a sand mill. The suspension was subsequently heated to 80° C. and set to a pH value of 11.5 with NaOH. Thereafter, 3.0% by weight SiO₂ was added in the form of potassium water glass within 30 minutes. After a retention time of 10 minutes, the pH value was lowered to a pH value of 4 within 150 minutes by adding HCl. After stirring for 10 minutes, 3.0% by weight Al₂O₃ was added in the form of sodium aluminate, together with HCl, within 30 minutes in such a way that the pH value remained constant at roughly 4 during this parallel addition.

The suspension was set to a pH value of 6.5 to 7 with NaOH and the material subsequently filtered, washed, dried and milled in a steam mill with added TMP (trimethylolpropane), as customary in practice.

The particle size d₅₀ was 0.56 μm, the specific surface area according to BET being 4 m²/g.

### Example 2

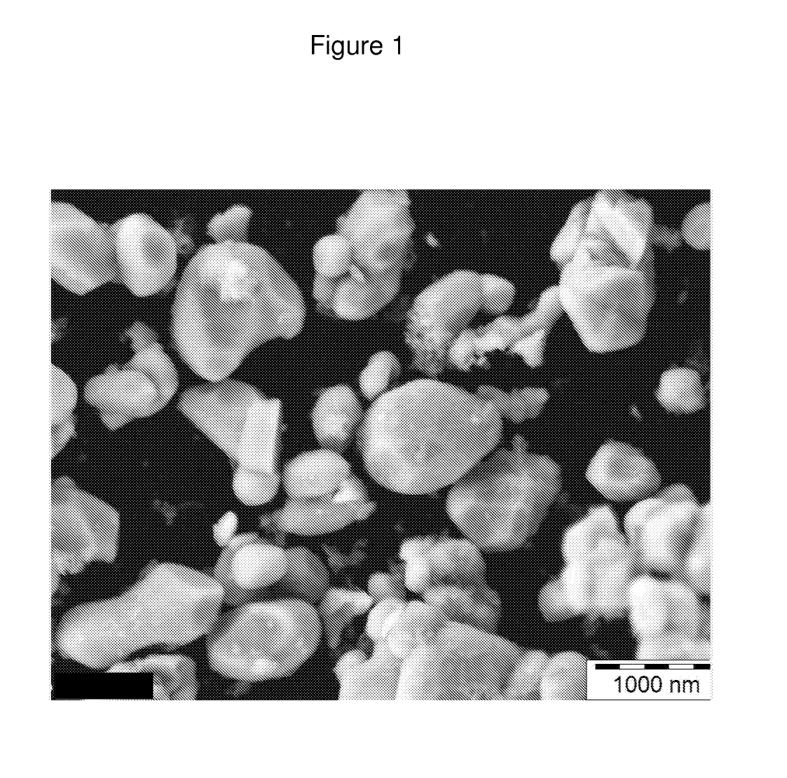

The procedure in Example 1 was repeated except that 0.4% by weight ZnO was added. The particle size d₅₀ was 0.88 μm, the specific surface area according to BET being 2 m²/g. FIG. 1 shows a scanning electron microscope (SEM) image of the particles.

### Reference Example

Washed titanium oxyhydrate paste like that in Example 1 was slurried (300 g/l TiO₂) and mixed with 0.4% by weight ZnO in the form of zinc oxide, 0.4% by weight Al₂O₃ in the form of aluminium sulphate, 0.22% by weight K₂O in the form of potassium hydroxide and 1% by weight rutile nuclei. The suspension was dried at 120° C. for 16 hours. 3 kg of the material were subsequently calcined in a rotary kiln at 980° C. for 2 hours and milled in a spiral jet mill. Approx. 0.2% by weight TMP was subsequently sprayed onto the particle surface.

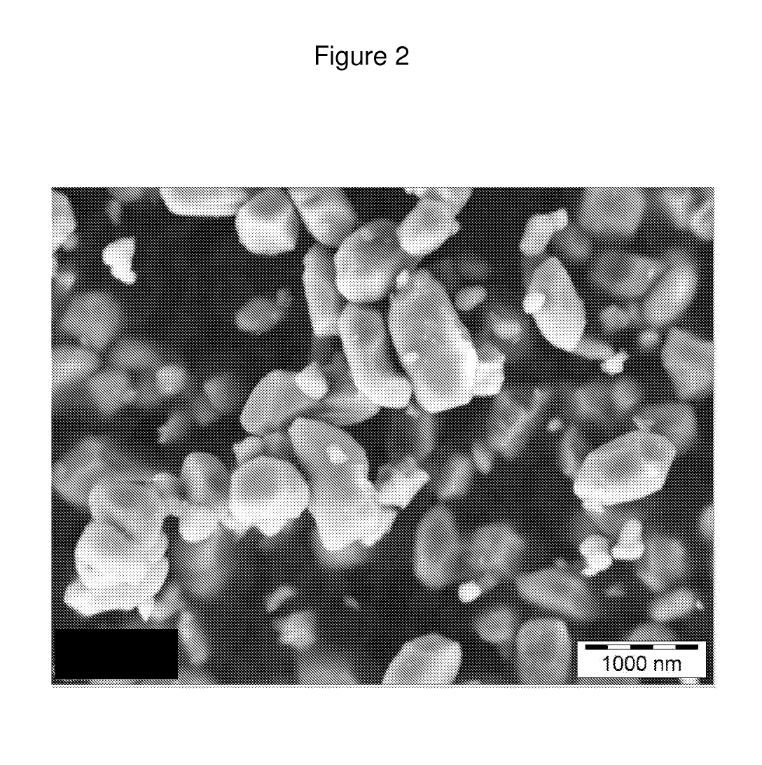

The particle size d₅₀ was 0.98 μm. FIG. 2 shows an SEM image of the particles. Compared to the particles from Examples 1 and 2, the particles display a pronounced rod shape.

The rutile TiO₂ particles manufactured in accordance with Example 1 and Example 2 were post-treated with SiO₂ and Al₂O₃ in the familiar manner and subsequently incorporated into a white alkyd paint system. The reflection of corresponding 90 μm paint drawdowns was measured with a Lambda 950 UV/Vis/NIR spectrophotometer with 150 mm integrating sphere and gloss film.

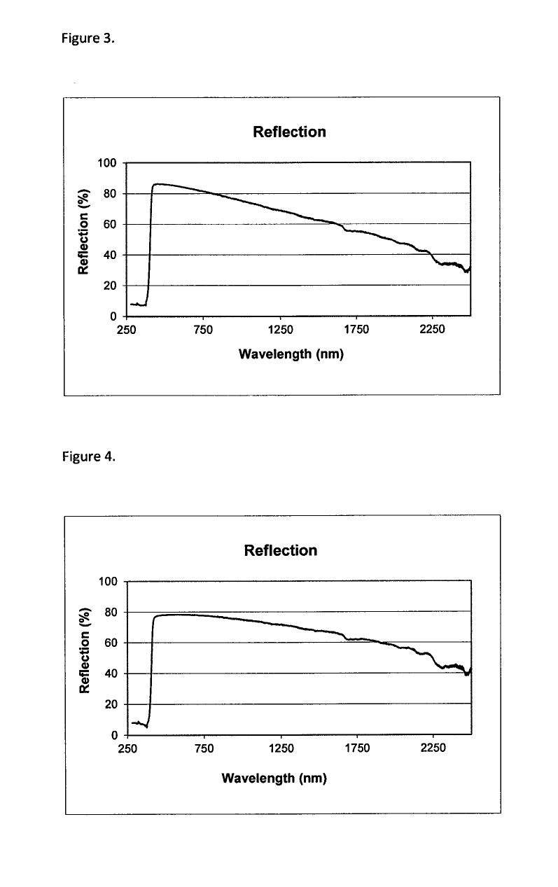

FIG. 3 (Example 1) and FIG. 4 (Example 2) show the reflection spectra measured. It can clearly be seen that, as the particle size increases, reflection decreases in the visible range and increases in the near IR range.

The above descriptions of certain embodiments are made for the purpose of illustration only and are not intended to be limiting in any manner. Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

What is claimed is:

1. Infrared-reflecting pigment comprising rutile titanium dioxide particles having a particle size d₅₀ in the range of from about 0.4 to about 1 μm and wherein the particles are doped with zinc and potassium and not doped with aluminium.

2. The particles of claim 1, wherein the particles contain from about 0.1 to about 0.8 weight percent zinc calculated as ZnO and based on the weight of titanium dioxide in the particles.

3. The particles of claim 2, wherein the particles contain from about 0.2 to about 0.4 weight percent zinc calculated as ZnO and based on the weight of titanium dioxide in the particles.

4. The particles of claim 3, wherein the particles contain from about 0.2 to about 0.25 weight percent zinc calculated as ZnO and based on the weight of titanium dioxide in the particles.

5. The particles of claim 2, wherein the particles contain from about 0.1 to about 0.4 weight percent potassium calculated as K₂O and based on the weight of titanium dioxide in the particles.

6. The particles of claim 5 wherein the titanium dioxide particles have a maximum height:width ratio of about 1.5:1.

7. The particles of claim 1, wherein the particles contain from about 0.1 to about 0.4 weight percent potassium calculated as K₂O and based on the weight of titanium dioxide in the particles.

8. The particles of claim 1, wherein the particles contain from about 0.18 to about 0.26 weight percent potassium calculated as K₂O and based on the weight of titanium dioxide in the particles.

9. The particles of claim 1 wherein the titanium dioxide particles have a maximum height:width ratio of about 1.5:1.

10. The particles of claim 4, wherein the particles contain from about 0.18 to about 0.26 weight percent potassium calculated as K₂O and based on the weight of titanium dioxide in the particles.

11. The particles of claim 10 wherein the particles have a maximum height:width ratio of about 1.5:1.

12. The particles of claim 1, wherein the titanium dioxide particles further comprise at least one inorganic and/or organic surface treatment.

13. A method for manufacturing an infrared-reflecting pigment comprising the steps of:
providing an iron/titanium-containing raw material;
digesting the raw material with sulfuric acid to produce iron sulfate and titanyl sulfate;
removing the iron sulphate;
hydrolysing the titanyl sulfate to form titanium oxyhydrate;
bleaching the titanium oxyhydrate;
mixing the bleached titanium oxyhydrate with rutile nuclei, a zinc compound and a potassium compound, but not with any aluminium compound to form a mixture;
calcining the mixture to produce rutile titanium dioxide particles having a particle size d₅₀ of from about 0.4 to about 1 μm.

14. The method of claim 13, wherein the zinc compound is added in an amount such that the resulting titanium dioxide particles contain from about 0.1 to about 0.8% by weight zinc calculated as ZnO and based on the weight of titanium dioxide in the particles.

15. The method of claim 14, wherein the zinc compound is added in an amount such that the resulting titanium dioxide particles contain from about 0.2 to about 0.4% by weight zinc calculated as ZnO and based on the weight of titanium dioxide in the particles.

16. The method of claim 15, wherein the zinc compound is added in an amount such that the resulting titanium dioxide particles contain from about 0.2 to about 0.25% by weight zinc calculated as ZnO and based on the weight of titanium dioxide in the particles.

17. The method of claim 14, wherein the potassium compound is added in an amount such that the resulting titanium dioxide particles contain from about 0.1 to about 0.4% by weight potassium calculated as K₂O and based on the weight of titanium dioxide in the particles.

18. The method of claim 17 wherein the resulting rutile titanium dioxide particles have a maximum height:width ratio of about 1.5:1.

19. The method of claim 17, wherein the rutile nuclei is added in an amount from about 0.5 to about 1.0% by weight, based on the weight of titanium dioxides in the particles.

20. The method of claim 13, wherein the potassium compound is added in an amount such that the resulting titanium dioxide particles contain from about 0.1 to about 0.4% by weight potassium calculated as K₂O and based on the weight of titanium dioxide in the particles.

21. The method of claim 17, wherein the potassium compound is added in an amount such that the resulting titanium dioxide particles contain from about 0.18 to about 0.26% by weight potassium calculated as K₂O and based on the weight of titanium dioxide in the particles.

22. The method of claim 13, wherein:
the zinc compound is added in an amount such that the resulting titanium dioxide particles contain from about 0.2 to about 0.25% by weight zinc calculated as ZnO and based on the weight of titanium dioxide in the particles; and
wherein the potassium compound is added in an amount such that the resulting titanium dioxide particles contain from about 0.18 to about 0.26% by weight potassium calculated as K₂O and based on the weight of titanium dioxide in the particles.

23. The method of claim 22 wherein the resulting rutile titanium dioxide particles have a maximum height:width ratio of about 1.5:1.

24. The method of claim 23 wherein the rutile nuclei is added in an amount from about 0.5 to about 1.0% by weight, based on the weight of titanium dioxides in the particles.

25. The method of claim 13 wherein the rutile nuclei is added in an amount from about 0.5 to about 1.0% by weight, based on the weight of titanium dioxides in the particles.

26. The method of claim 13 wherein the resulting rutile titanium dioxide particles have a maximum height:width ratio of about 1.5:1.

27. The method of claim 13, further comprising subsequently subjecting the rutile titanium dioxide particles to at least one inorganic and/or organic surface treatment.

28. The method of claim 13 further comprising using the resulting rutile titanium dioxide particles in paints, coatings, plastics, plasters or paving stones.
